(19) United States
(12) Patent Application Publication
(10) Pub. No.: US 2025/0229482 A1
(43) Pub. Date: Jul. 17, 2025

(54) ANTI-ADHESION BETWEEN SECTIONS IN FDM-PRINTED OBJECT

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 18/832,393

(22) PCT Filed: Jan. 26, 2023
(86) PCT No.: PCT/EP2023/051914

§ 371 Date: Jul. 23, 2024

(30) Foreign Application Priority Data
Jan. 31, 2022 (EP) 22154171.7

(51) Int. Cl. B29C 64/118; B29C 64/321; B29K 27/12; B29L 31/00; B33Y 10/00; B33Y 70/10; B33Y 80/00

(52) U.S. Cl. CPC B29C 64/118; B29C 64/321; B33Y 10/00; B33Y 70/10; B29K 2027/12; B29L 2031/747; B33Y 80/00

(57) ABSTRACT

The invention provides a method for producing a 3D item (1) by means of fused deposition modelling, wherein: (A) the method comprises layer-wise depositing 3D printable material (201) to provide the 3D item (1) comprising a plurality of layers (322) of 3D printed material (202): (B) the 3D printable material (201) comprises (i) first 3D printable material (1201) comprising a fluoropolymer (1403) in a first outer region (1270) (of the first 3D printable material (1201)) enclosing a first inner region (of the first 3D printable material (1201)), and (ii) second 3D printable material (2201) free from a fluoropolymer (1403) in a second outer region (2270) (of the second 3D printable material (2201)) enclosing a second inner region (of the second 3D printable material (2201)); and (C) (a) in one or more first sections (280) of two adjacent layers (322) at least one of the layers (322) comprises first 3D printed material (1202) comprising the fluoropolymer (1403) in the first outer region (1270) (of the 3D printed material (202)), and (b) in one or more second sections (290) of two adjacent layers (322) the adjacent layers (322) both comprise second 3D printed material (2202) free from the fluoropolymer (1403) in the second outer regions (2270) (of the 3D printed material (202)).

### FIELD OF THE INVENTION

The invention relates to a method for manufacturing a 3D (printed) item. The invention also relates to the 3D (printed) item obtainable with such method. Further, the invention relates to a lighting device including such 3D (printed) item. Yet, the invention also relates to a filament that may be used in the method for manufacturing the 3D printed item.

### BACKGROUND OF THE INVENTION

The use of fluoropolymers in the 3D printing of articles is known in the art.

WO2017173258A1, for instance, describes and/or alleges a fluoropolymer filament for use in 3-D printing, and 3-D printed fluoropolymer articles having low warpage, excellent chemical resistance, excellent water resistance, flame resistance, and good mechanical integrity. Additionally, the articles of the invention have good shelf life without the need for special packaging. In particular, the invention relates to 3-D printed polyvinylidene fluoride (PVDF) articles, and in particular material extrusion 3-D printing The articles may be formed from PVDF homopolymers, copolymers, and polymer blends with appropriately defined low shear melt viscosity. The PVDF may optionally be a filled PVDF formulation. The physical properties of the 3-D printed articles can be maximized and warpage minimized by optimizing processing parameters.

WO2021101868A1 discloses the use of compatible, semi-miscible or miscible polymer compositions as support structures for the 3D printing of objects, including those made from polyether-block-amide copolymers such as PEBAX® block copolymers from Arkema, polyamides such as RILSAN® polyamides from Arkema, polyether ketone ketone such as KEPSTAN® PEKK from Arkema, and fluoropolymers, such a KYNAR® PVDF from Arkema, especially objects of polyvinylidene fluoride and its copolymers. The support structure composition provides the needed adhesion to the build plate and to the printed object and support strength during the 3D printing process, yet it is removable after the fluoropolymer object has cooled.

WO2018149758A1 discloses a method for manufacturing three-dimensional objects via an additive manufacturing system, using a fluorinated thermoplastic elastomer.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals and polymers. 3D printing can also be used in producing molds which can then be used for replicating objects.

For the purpose of making molds, the use of polyjet technique has been suggested. This technique makes use of layer by layer deposition of photo-polymerisable material which is cured after each deposition to form a solid structure. While this technique produces smooth surfaces the photo curable materials are not very stable, and they also have relatively low thermal conductivity to be useful for injection molding applications.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions.

There is a desire to create improved and/or advanced 3D printed objects e.g. with less warpage and/or increased functionality is identified. Further, a desire to provide in a relatively simple 3D printed objects having controlled properties, like controlled mechanical properties, is identified.

Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

Hence, in a first aspect the invention provides a method for producing a 3D item (“3D printed item” or “item”) by means of fused deposition modelling. Especially, the method may comprise layer-wise depositing 3D printable material to provide the 3D item comprising one or more layers, especially a plurality of layers, of 3D printed material.

In the context of the present invention, the term “3D printable material” refers to the feedstock used for performing the method, and may therefore also be called “3D printable feedstock”. The term “3D printed material” refers to the material that constitutes the 3D item that is produced by the method.

In embodiments, the 3D printable material may comprise first 3D printable material comprising a fluoropolymer in a first outer region (of the first 3D printable material) enclosing a first inner region (of the first 3D printable material). Further, the 3D printable material may comprise second 3D printable material free from a fluoropolymer in a second outer region (of the second 3D printable material) enclosing a second inner region (of the second 3D printable material).

In the context of the present invention, the terms “first 3D printable material” and “second 3D printable material” refer to components of the 3D printable material. In other words, these terms refer to first and second components of the feedstock used for performing the method, and may also be called “first 3D printable material component” and “second 3D printable material component”, respectively.

Further, in embodiments in one or more first sections of two adjacent layers (of the 3D printed item) at least one of the layers may comprise first 3D printed material comprising the fluoropolymer in the first outer region (of the 3D printed material). Alternatively or additionally, in embodiments in one or more second sections of two adjacent layers (of the 3D printed item) the adjacent layers both comprise second 3D printed material free from the fluoropolymer in the second outer regions (of the 3D printed material). Hence, especially the invention provides in embodiments a method for producing a 3D item by means of fused deposition modelling, wherein: (A) the method comprises layer-wise depositing 3D printable material to provide the 3D item comprising a plurality of layers of 3D printed material; (B) the 3D printable material comprises (i) first 3D printable material comprising a fluoropolymer in a first outer region (of the first 3D printable material) enclosing a first inner region (of the first 3D printable material), and (ii) second 3D printable material free from a fluoropolymer in a second outer region (of the second 3D printable material) enclosing a second inner region (of the second 3D printable material); and (C) (a) in one or more first sections of two adjacent layers at least one of the layers comprises first 3D printed material comprising the fluoropolymer in the first outer region (of the 3D printed material), and (b) in one or more second sections of two adjacent layers the adjacent layers both comprise second 3D printed material free from the fluoropolymer in the second outer regions (of the 3D printed material).

Withs such method, it may be possible to create 3D printed items that may have flexible parts, or that are flexible, or have porous parts or that are porous. Further, it may be possible to control locally the flexibility and/or permeability of the 3D printed item. Further, by controlling the 3D printing of the 3D printable material, in a relatively simple way such 3D printed items may be provided.

As indicated above, the invention provides a method for producing a 3D item by means of fused deposition modelling. Hence, the 3D item may at least partly be produced by fused deposition modelling. Especially, the method may comprise layer-wise depositing 3D printable material to provide the 3D item comprising one or more layers of 3D printed material, especially a plurality of layers of 3D printed material. Hence, the 3D printable material when 3D printed may be indicated as “3D printed material”.

The 3D printable material may comprise at least two types of materials. These materials may have different compositions, especially in an outer region of the 3D printable material. The outer region may also be indicated as “periphery”. One type of material may comprise a fluoropolymer in the outer region whereas the other material may free of such fluoropolymer.

Herein, the term “fluroropolymer” may also refer to a plurality of different fluoropolymers. Herein, the phrase “free from a fluoropolymer”, and similar phrases, may especially indicate that the weight percentage (wt %)) of fluoropolymer(s) in the indicated region may be less than about 5 wt %, more especially less than about 1 wt %, such as less than about 0.5 wt %. In embodiments, the weight percentage of fluoropolymer(s) in the indicated region may be less than about 0.1 wt %, such as less than about 0.05 wt %. Hence, the phrase “free from a fluoropolymer”, and similar phrases, may especially indicate “substantially free from a fluoropolymer” or “the fluoropolymer is substantially absent”, and similar phrases. Further, especially the phrase “free from a fluoropolymer”, and similar phrases may indicate free from any fluoropolymer. Hence, the phrase “comprising a fluoropolymer”, and similar phrases, may especially indicate that the weight percentage of fluoropolymer(s) in the indicated region may be at least about 5 wt %, such as at least about 10 wt %, like in embodiments at least about 20 wt %.

The first 3D printable material may comprise a combination of a fluoropolymer and a non-fluoropolymer. The non-fluoropolymer may be the same non-fluoropolymer as of the first 3D printable material, though this is not necessarily the same.

In embodiments, the weight percentage of fluoropolymer(s) in the first 3D printable material may be at least about 5 wt %, such as at least about 10 wt %, like in embodiments at least about 20 wt %. In further embodiments, the weight percentage of fluoropolymer(s) in the first 3D printable material may be at least about 30 wt %, such as at least about 40 wt %, or even at least about 50 wt %. In embodiments, the weight percentage of fluoropolymer(s) in the second 3D printable material may be less than about 5 wt %, more especially less than about 1 wt %, such as less than about 0.5 wt %. In embodiments, the weight percentage of fluoropolymer(s) in the second 3D printable material may be less than about 0.1 wt %, such as less than about 0.05 wt %.

The first 3D printable material (and the first 3D printed material) may thus comprise a fluoropolymer. In embodiments, the first 3D printable material (and the first 3D printed material) may essentially consist of the fluoropolymer. In other embodiments, the first 3D printable material (and the first 3D printed material) may comprise a combination of a non-fluoropolymer thermoplastic polymer and a fluoropolymer. For instance, the first 3D printable material (and the first 3D printed material) may comprise a non-fluoropolymer thermoplastic polymer with fluoropolymer particles embedded therein.

The 3D printable material may be provided in several ways. It may be provided as filament. In such embodiments, the filament may comprise different outer regions, one or more comprising the fluoropolymer and one or more not comprising the fluoropolymer. Another way may be to print with two different materials, either consecutively with the same nozzle, or (consecutively) with two or more nozzles. In this way, different materials may be printed. Even in the embodiments with two or more nozzles, also the above indicated filament embodiments(s) may be applied. An even better control may however be using different materials for the different nozzles. Yet another way may be using a core-shell nozzle. In this way an outer nozzle may be fed with one of the type of (3D printable) materials and an inner nozzle/core nozzle may be fed with another type of the (3D printable) materials. By controlling the extrusion of the 3D printable material via the different parts of the core-shell nozzle, 3D printed material may be provided with at one part a fluoropolymer in an outer region and in another part the outer region may be substantially free from the fluoropolymer.

When using a core-shell nozzle, the 3D printable material provided to the core of the core-shell nozzle may be a filament comprising 3D printable material or may be particulate 3D printable material. Both type of feeds may be extruded via the core of the core-shell nozzle. The 3D printable material provided to a shell of the core-shell nozzle may be particulate 3D printable material. Such particulate 3D printable material (feed) may be extruded via the shell of the core-shell nozzle. When using a nozzle with a single opening, the 3D printable material provided to nozzle may be a filament comprising 3D printable material or may be particulate 3D printable material. Both type of feeds may be extruded via the nozzle.

In sections where one layer comprises fluoropolymer in an outer region adjacent to another layer having no fluoropolymer in its out region or also comprising fluoropolymer in the outer region, the adhesion between the layers will be very low, or may even be absent. Hence, an opening, especially a slit, may be created, where there is hardly any binding between the layers and where effectively the 3D printed material may be (a bit permeable). Hence, the 3D printed item may in embodiments be light transmissive. However, in other sections where the outer regions of both the adjacent layers are free from fluoropolymer, there may be a (good) binding between the adjacent layers.

Instead of the term “outer region”, also the term “periphery may be applied.

A fluoropolymer may be in an outer region when the 3D printable material comprises such fluoropolymer or when the outer region of such 3D printable material is enriched with such fluoropolymer, such as when having a shell comprising the fluoropolymer. A fluoropolymer may be substantially absent in an outer region when the 3D printable material does not comprise such fluoropolymer or when the outer region of such 3D printable material is free from such fluoropolymer, such as when having a shell free from the fluoropolymer.

In embodiments, the 3D printable material may comprise core-shell material. In embodiments, the 3D printable material may comprise a concentration gradient of the fluoropolymer, with either a higher weight percentage in the outer region than in the inner region, or the other way around. Likewise this may apply to the 3D printed material.

Therefore, in embodiments the 3D printable material may comprise first 3D printable material comprising a fluoropolymer in a first outer region enclosing a first inner region. Alternatively or additionally, the 3D printable material may comprise second 3D printable material free from a fluoropolymer in a second outer region enclosing a second inner region.

As can be derived from the above, in use the first 3D printable material and the second 3D printable material may be different feeds to different parts of a core-shell nozzle, or may be provided as filament comprising one or more first parts comprising the first 3D printable material and comprising one or more second parts comprising the second 3D printable material.

The method may be executed in such a way with the 3D printable material comprising the first 3D printable material and/or the second 3D printable material that one or more first sections are provided wherein there may be substantially no binding between two adjacent layers, because at least one thereof may comprise the fluoropolymer in an outer region. Alternatively or additionally, the method may be executed in such a way with the 3D printable material comprising the first 3D printable material and/or the second 3D printable material that one or more second sections are provided wherein there may binding between two adjacent layers, because none of the two adjacent layers comprise the fluoropolymer in a respective outer region.

Hence, for the thus obtained 3D printed item may apply that in one or more first sections of two adjacent layers at least one of the layers may comprise first 3D printed material comprising the fluoropolymer in the first outer region. Alternatively or additionally, for the thus obtained 3D printed item may apply that in one or more second sections of two adjacent layers the adjacent layers may both comprise second 3D printed material free from the fluoropolymer in the second outer regions.

In embodiments, the fluoropolymer (of the first 3D printable material and the first 3D printed material) may comprise one or more of polyvinylfluoride (PVF), polyvinylidene fluoride (PVDF), polytetrafluoroethylene (PTFE), polychloro-trifluoroethylene (PCTFE), perfluoroalkoxy polymer (PFA, MFA), fluorinated ethylene-propylene (FEP), polyethylenetetrafluoroethylene (ETFE), and a copolymer made from 2,2-bistrifluoromethyl-4,5-difluoro-1,3-dioxole (PPD) and tetrafluoroethylene (TFE).

Alternatively or additionally, the second 3D printable material and the second 3D printed material may comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

In embodiments, the first 3D printable material (and the 3D printed material) may comprise a thermoplastic polymer. Hence, in specific embodiments the first 3D printable material (and the 3D printed material) may comprise a thermoplastic fluoropolymer. In embodiments, the second 3D printable material (and the 3D printed material) may comprise a thermoplastic polymer. Hence, in specific embodiments the second 3D printable material (and the 3D printed material) may comprise a thermoplastic non-fluoropolymer.

In embodiments, the second 3D printable material may be hydrophilic. Hence, the 3D printable material or the 3D printed material may comprise a hydrophilic thermoplastic polymer and/or may comprise a thermoplastic polymer with hydrophilic particles embedded therein.

Note that in embodiments an outer region may comprise one or more different polymeric materials. Alternatively or additionally, in embodiments an inner region may comprise one or more different polymeric materials.

In non-core shell material, the composition of the outer region and the inner region may thus be essentially identical.

In embodiments, the first 3D printable material (and the first 3D printed material) may have a first glass transition temperature Tg1 and/or a first melting temperature Tm1. Further, in embodiments the second 3D printable material (and the second 3D printed material) may have a second glass transition temperature Tg2 and/or a second melting temperature Tm2. In embodiments, Tg2−30° C.≤Tg1≤Tg2+30° C. and/or Tm2−30° C.≤Tm1≤Tm2+30° C. In this way, the 3D printable material, or in specific embodiments a filament comprising one or both of these 3D printable material, may be processed well.

Due to the presence of the fluoropolymer in the first sections, in the first sections there may substantially be no binding between the adjacent layers. This may lead to openings, especially slit-like openings and/or movability of at least part of one layer relative to at least part of another (adjacent) layer. Therefore in embodiments one or more of the following applies: (a) in the one or more first sections the adjacent layers are movable relative to each other, and (b) in the one or more first sections the adjacent layers have an opening between the adjacent layers. Especially, the openings may be slits or slit openings, see further also below.

In embodiments, for one or more of the one or more first sections of two adjacent layers may apply that one of the layers comprise first 3D printed material comprising the fluoropolymer in the first outer region (in the respective one or more of the one or more first sections). In other embodiments, in at least one of the one or more first sections of two adjacent layers both layers comprise first 3D printed material comprising the fluoropolymer in the first outer regions. This may e.g. in embodiments be achieved when using a core-shell nozzle and providing the fluoropolymer comprising 3D printable material to one section of the core-shell nozzle and providing 3D printable material free from the fluoropolymer to another section of the core-shell nozzle, and controlling the flow of 3D printable material through the respective core-shell sections, including temporarily terminating one of the flows.

Therefore, in embodiments the method may comprise using a core-shell printer nozzle, wherein the method may comprise controlling deposition of the relative amounts of first 3D printable material and the second 3D printable material to provide the one or more first sections and one or more second sections.

As indicated above, there may be one or more first sections and one or more second sections. The latter may provide stability to the 3D printed item. Therefore, in specific embodiments each first section may be configured between two second sections.

A length of the first sections may be relatively freely chosen, though in general, the lengths may be at maximum 50 mm, such as at maximum 30 mm, like in embodiments at maximum 20 mm. In other embodiments, the first sections may have lengths of at least about 0.1 mm, more especially at least about 0.5 mm, like more especially at least about 1 mm. Hence, in specific embodiments the one or more first sections have a section length (Ls1), wherein Ls1≤20 mm.

Further, it may be desirable to relate the section length to a height of the layer of at least one of the two adjacent layers forming the section. Therefore, in embodiments the layers of the one or more first sections have a layer height (HL1), wherein the one or more first sections have a section length (Ls1). In specific embodiments, 0.1≤Ls1/HL1≤50, more especially 1≤Ls1/HL1≤40. Yet even more especially, in embodiments 2≤Ls1/HL1≤40 may apply. However, other embodiments are herein not excluded. The section length may be the length over which there may essentially no binding between adjacent layers. In embodiments, the section length may essentially be the length of the inter layer space

Further, the one or more first sections may have an interlayer space height (Hs1). Especially, in embodiments Hs1/Ls1<1, more especially Hs1/Ls1≤2, yet even more especially Hs1/Ls1≤5. Further, in specific embodiments Hs1/Ls1≤10, such as about Hs1/Ls1≤20. Therefore, the openings may especially comprise slit (openings). The adjacent layers may touch each other as the first section. In such embodiments, the interlayer space height may essentially be zero. However, at such sections it may in embodiments be possible to move the layer relative to each other, as there may essentially be no binding.

In embodiments, the method may comprise depositing 3D printable material to provide (a) core-shell 3D printed material and (b) non-core-shell 3D printed material; wherein one or more of the following applies: (I) (i) the core-shell 3D printed material comprises a core and a shell surrounding at least part of the core, wherein the shell comprises the fluoropolymer; and (ii) the second outer region of the non-core-shell 3D printed material is free from the fluoropolymer; and (II) (a1) the core-shell 3D printed material comprises a core and a shell surrounding at least part of the core, wherein the core comprises the fluoropolymer, wherein the shell is free from the fluoropolymer; and (b1) the second outer region of the non-core-shell 3D printed material comprises the fluoropolymer. Hence, in embodiments (i) the core-shell 3D printed material comprises a core and a shell surrounding at least part of the core, wherein the shell comprises the fluoropolymer; and (ii) the second outer region of the non-core-shell 3D printed material is free from the fluoropolymer. Alternatively or additionally, in embodiments (a1) the core-shell 3D printed material comprises a core and a shell surrounding at least part of the core, wherein the core comprises the fluoropolymer, wherein the shell is free from the fluoropolymer; and (b1) the second outer region of the non-core-shell 3D printed material comprises the fluoropolymer.

In (other) embodiments, the method may comprise depositing 3D printable material to provide (a) core-shell 3D printed material and (b) non-core-shell 3D printed material; wherein one or more of the following applies: (I) (i) the core-shell 3D printed material comprises a core, free from the fluoropolymer, and a shell surrounding at least part of the core, wherein the shell comprises the fluoropolymer; and (ii) the second outer region of the non-core-shell 3D printed material is free from the fluoropolymer; and (II) (a1) the core-shell 3D printed material comprises a core and a shell surrounding at least part of the core, wherein the core comprises the fluoropolymer, wherein the shell is free from the fluoropolymer; and (b1) the second outer region of the non-core-shell 3D printed material is free from the fluoropolymer. Hence, in embodiments (i) the core-shell 3D printed material comprises a core, free from the fluoropolymer, and a shell surrounding at least part of the core, wherein the shell comprises the fluoropolymer; and (ii) the second outer region of the non-core-shell 3D printed material is free from the fluoropolymer. Alternatively or additionally, in embodiments (a1) the core-shell 3D printed material comprises a core and a shell surrounding at least part of the core, wherein the core comprises the fluoropolymer, wherein the shell is free from the fluoropolymer; and (b1) the second outer region of the non-core-shell 3D printed material is free from the fluoropolymer.

Starting material for one or more of these embodiments may in embodiments be core-shell material, wherein either the shell or the core comprises the fluoropolymer and wherein either the core or the shell is free from the fluoropolymer, respectively.

As indicated above, the method comprises depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. In embodiments, the 3D printable material may be printed as a filament and deposited as such. The 3D printable material may be provided as filament or may be formed into a filament. Hence, whatever starting materials are applied, a filament comprising 3D printable material may be provided by the printer head and 3D printed. The term “extrudate” may be used to define the 3D printable material downstream of the printer head, but not yet deposited. The latter may be indicated as “3D printed material”. In fact, the extrudate may be considered to comprises 3D printable material, as the material is not yet deposited. Upon deposition of the 3D printable material or extrudate, the material may thus be indicated as 3D printed material. Essentially, the materials may be the same material, as the thermoplastic material upstream of the printer head, downstream of the printer head, and when deposited, may essentially be the same material(s).

Herein, the term “3D printable material” may also be indicated as “printable material”. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tm. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action may comprises heating the 3D printable material above the glass transition and in embodiments above the melting temperature (especially when the thermoplastic polymer is a semi-crystalline polymer). In yet another embodiment, the 3D printable material comprises a (thermoplastic) polymer having a melting point (Tₘ), and the 3D printing stage may comprise heating the 3D printable material to be deposited on the receiver item to a temperature of at least the melting point. The glass transition temperature is in general not the same thing as the melting temperature. Melting is a transition which may occur in crystalline polymers. Melting may happen when the polymer chains fall out of their crystal structures, and become a disordered liquid. The glass transition may be a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

As indicated above, the invention may thus provide a method comprising providing a filament of 3D printable material and printing during a printing stage said 3D printable material on a substrate, to provide said 3D item.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc. Optionally, the 3D printable material may comprise a 3D printable material selected from the group consisting of Urea formaldehyde, Polyester resin, Epoxy resin, Melamine formaldehyde, thermoplastic elastomer, etc. . . . . Optionally, the 3D printable material may comprise a 3D printable material selected from the group consisting of a polysulfone. Elastomers, especially thermoplastic elastomers, may especially be interesting as they are flexible and may help obtaining relatively more flexible filaments comprising the thermally conductive material. A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Suitable thermoplastic materials, such as also mentioned in WO2017/040893, may include one or more of polyacetals (e.g., polyoxyethylene and polyoxymethylene), poly(C₁₋₆ alkyl) acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl) methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Embodiments of polyamides may include, but are not limited to, synthetic linear polyamides, e.g., Nylon-6,6; Nylon-6,9; Nylon-6,10; Nylon-6,12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are poly(C₁₋₆ alkyl) acrylates and poly(C₁₋₆ alkyl) methacrylates, which include, for instance, polymers of methyl acrylate, ethyl acrylate, acrylamide, methacrylic acid, methyl methacrylate, n-butyl acrylate, and ethyl acrylate, etc. In embodiments, a polyolefine may include one or more of polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

In specific embodiments, the 3D printable material (and the 3D printed material) may comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

The term 3D printable material is further also elucidated below, but may especially refer to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

The printable material in embodiments may comprise particulate material, i.e. particles embedded in the printable polymeric material, which particles form a substantially discontinuous phase. The number of particles in the total mixture may especially not be larger than 60 vol. %, relative to the total volume of the printable material (including the (anisotropically conductive) particles) especially in applications for reducing thermal expansion coefficient. For optical and surface related effect number of particles in the total mixture is equal to or less than 20 vol. %, such as up to 10 vol. %, relative to the total volume of the printable material (including the particles). Hence, the 3D printable material may especially refer to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives.

The printable material may be printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc. . . . . Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. . . . . Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material may be deposited, by which the 3D printed item may be generated (during the printing stage). The 3D printed item may show a characteristic ribbed structures (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, etc. . . . . Post-processing may include smoothening the ribbed structures, which may lead to an essentially smooth surface.

Further, the invention relates to a software product that can be used to execute the method described herein. Therefore, in yet a further aspect the invention also provides a computer program product, when running on a computer which is functionally coupled to or comprised by a fused deposition modeling 3D printer, is capable of bringing about the method as described herein. Hence, in an aspect the invention (thus) provides a software product, which, when running on a computer is capable of bringing about (one or more embodiments of) the method (for producing a 3D item by means of fused deposition modelling) as described herein.

The herein described method provides 3D printed items. Hence, the invention also provides in a further aspect a 3D printed item obtainable with the herein described method. In a further aspect a 3D printed item obtainable with the herein described method is provided. Especially, the invention provides a 3D item comprising 3D printed material, wherein the 3D item comprises a plurality of layers of 3D printed material. In embodiments, the 3D printed material may comprise first 3D printed material comprising a fluoropolymer in a first outer region of the first 3D printed material enclosing a first inner region of the first 3D printed material. Alternatively or additionally, the 3D printed material may comprise second 3D printed material free from a fluoropolymer in a second outer region of the second 3D printed material enclosing a second inner region of the second 3D printed material. Especially, in embodiments in one or more first sections of two adjacent layers at least one of the layers may comprise first 3D printed material comprising the fluoropolymer in the first outer region, and/or in one or more second sections of two adjacent layers the adjacent layers may both comprise second 3D printed material free from the fluoropolymer in the second outer regions. Therefore the invention especially provides in embodiments a 3D item comprising 3D printed material, wherein the 3D item comprises a plurality of layers of 3D printed material, wherein: (I) the 3D printed material comprises (i) first 3D printed material comprising a fluoropolymer in a first outer region of the first 3D printed material enclosing a first inner region of the first 3D printed material, and (ii) second 3D printed material free from a fluoropolymer in a second outer region of the second 3D printed material enclosing a second inner region of the second 3D printed material; and (II) (a) in one or more first sections of two adjacent layers at least one of the layers comprises first 3D printed material comprising the fluoropolymer in the first outer region, and (b) in one or more second sections of two adjacent layers the adjacent layers both comprise second 3D printed material free from the fluoropolymer in the second outer regions.

Especially, the 3D item comprises one or more layers of 3D printed material. More especially, the 3D item comprises a plurality of layers of 3D printed material. The 3D item may comprise two or more, like at least 5, such as at least 10, like in embodiments at least 20 layers of 3D printed material.

The 3D printed item may comprise a plurality of layers on top of each other, i.e. stacked layers. The width (thickness) and height of (individually 3D printed) layers may e.g. in embodiments be selected from the range of 100-5000 μm, such as 200-2500 μm, with the height in general being smaller than the width. For instance, the ratio of height and width may be equal to or smaller than 0.8, such as equal to or smaller than 0.6.

Layers may be core-shell layers or may consist of a single material. Within a layer, there may also be a change in composition, for instance when a core-shell printing process was applied and during the printing process it was changed from printing a first material (and not printing a second material) to printing a second material (and not printing the first material).

At least part of the 3D printed item may include a coating.

Some specific embodiments in relation to the 3D printed item have already been elucidated above when discussing the method. Below, some specific embodiments in relation to the 3D printed item are discussed in more detail.

In embodiments, the 3D item may comprise a first area having a first area size A1 selected from the range of at least 1 mm², such as selected from the range of 1-1600 mm², comprising n1 first sections. In embodiments n1=1. In further embodiments, n1 is at least 2. Especially, in embodiments n1≥4. Especially, each first sections may have a section length (Ls1). In embodiments, the first area may comprise a cumulative section length LS1≥1 mm, more especially LS1≥5 mm, such as especially LS1≥10 mm. More especially, in embodiments LS1≥20 mm. Especially, each first section may be configured adjacent to a second section. Further, in embodiments the 3D item may also comprise a second area having a second area size A2 selected from the range of at least 1 mm2, such as having a second area size A2 selected from the range of 1-1600 mm2, comprising no first sections. Hence, the 3D printed item may have a first area or part that is permeable. The 3D printed item 1 may in embodiments also be transmissive for light, due to the presence of the first sections.

In embodiments, one or more of the following may apply: (I) (i) the core-shell 3D printed material may comprise a core and a shell surrounding at least part of the core, wherein the shell may comprise the fluoropolymer; and (ii) the second outer region of the non-core-shell 3D printed material may be free from the fluoropolymer; and (II) (a) the core-shell 3D printed material may comprise a core and a shell surrounding at least part of the core, wherein the core may comprise the fluoropolymer, wherein the shell may be free from the fluoropolymer; and (b) the second outer region of the non-core-shell 3D printed material may comprise the fluoropolymer. These may e.g. be available in first sections.

The term section may thus especially refer to a part of the 3D printed item including part of a first layer and part of a second layer, wherein the first and the second layer are adjacent.

In embodiments, one or more of the following may apply: (I) (i) the core-shell 3D printed material may comprise a core and a shell surrounding at least part of the core, wherein the shell may be free from the fluoropolymer; and (ii) the second outer region of the non-core-shell 3D printed material may also be free from the fluoropolymer; and (II) (a) the core-shell 3D printed material may comprise a core and a shell surrounding at least part of the core, wherein the core may comprise the fluoropolymer, wherein the shell may be free from the fluoropolymer; and (b) the second outer region of the non-core-shell 3D printed material may be free from the fluoropolymer. These may e.g. be available in second sections.

In embodiments, the fluoropolymer (of the first 3D printed material) may comprise one or more of polyvinylfluoride (PVF), polyvinylidene fluoride (PVDF), polytetrafluoroethylene (PTFE), polychlorotrifluoroethylene (PCTFE), perfluoroalkoxy polymer (PFA, MFA), fluorinated ethylene-propylene (FEP), polyethylenetetrafluoroethylene (ETFE), and a copolymer made from 2,2-bistrifluoromethyl-4,5-difluoro-1,3-dioxole (PPD) and tetrafluoroethylene (TFE). Alternatively or additionally, in embodiments the second 3D printed material comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

In embodiments, the following may apply: (a) in the one or more first sections the adjacent layers are movable relative to each other, and (b) in the one or more first sections the adjacent layers have an opening between the adjacent layers. In embodiments, each first section may be configured between two second sections. In specific embodiments, the layers of the one or more first sections may have a layer height (HL1), wherein the one or more first sections may in embodiments have a section length (Ls1). Especially, in embodiments 2≤Ls1/HL1≤40. Further, in specific embodiments Ls1≤20 mm. In embodiments, in at least one of the one or more first sections of two adjacent layers both layers may comprise first 3D printed material comprising the fluoropolymer in the first outer regions.

In embodiments, the 3D item may comprise at least 2 first sections and at least 2 second sections, such as at least at least 4 first sections and at least 4 second sections. In embodiments, the 3D item may comprise at least 10 first sections and at least 10 second sections, such as at least at least 20 first sections, such as at least 100 first sections, and at least 20 second sections.

The (with the herein described method) obtained 3D printed item may be functional per se. For instance, the 3D printed item may be a lens, a collimator, a reflector, etc. . . . . The thus obtained 3D item may (alternatively) be used for decorative or artistic purposes. The 3D printed item may include or be provided with a functional component. The functional component may especially be selected from the group consisting of an optical component, an electrical component, and a magnetic component. The term “optical component” especially refers to a component having an optical functionality, such as a lens, a mirror, a light transmissive element, an optical filter, etc. . . . . The term optical component may also refer to a light source (like a LED). The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc. . . . . Alternatively, or additionally, the functional component may comprise a thermal component (e.g. configured to cool or to heat an electrical component). Hence, the functional component may be configured to generate heat or to scavenge heat, etc. . . . .

As indicated above, the 3D printed item maybe used for different purposes. Amongst others, the 3D printed item maybe used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific embodiments the 3D item may be configured as one or more of (i) at least part of a lighting device housing, (ii) at least part of a wall of a lighting chamber, and (iii) an optical element. As a relative smooth surface may be provided, the 3D printed item may be used as mirror or lens, etc. . . . . In embodiments, the 3D item may be configured as shade. A device or system may comprise a plurality of different 3D printed items, having different functionalities.

Returning to the 3D printing process, a specific 3D printer may be used to provide the 3D printed item described herein. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material according to the method as defined herein.

The printer nozzle may include a single opening. In other embodiments, the printer nozzle may be of the core-shell type, having two (or more) openings. The term “printer head” may also refer to a plurality of (different) printer heads; hence, the term “printer nozzle” may also refer to a plurality of (different) printer nozzles.

The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material to a substrate, according to the method as defined herein.

Especially, the 3D printer may comprise a controller (or may be functionally coupled to a controller) that is configured to execute in a controlling mode (or “operation mode”) the method as described herein. Instead of the term “controller” also the term “control system” (see e.g. above) may be applied.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface. The control system may also be configured to receive and execute instructions form a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology. The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed. However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability). Hence, in embodiments, the control system may control in dependence of one or more of an input signal of a user interface, a sensor signal (of a sensor), and a timer. The term “timer” may refer to a clock and/or a predetermined time scheme.

In yet a further aspect, the invention also provides a filament comprising 3D printable material. The filament may comprise a fluoropolymer in a first outer region (of the filament) enclosing a first inner region (of the filament). Further, the filament may comprise a second outer region (of the filament) enclosing a second inner region (of filament), wherein the second outer region may be free from a fluoropolymer. Therefore, especially the invention provides in embodiments a filament comprising 3D printable material, wherein the filament comprises (i) a fluoropolymer in a first outer region enclosing a first inner region (of the filament), and (ii) a second outer region (enclosing a second inner region (of filament), wherein the second outer region is free from a fluoropolymer.

In embodiments, the filament may comprise a plurality of first outer regions and a plurality of second outer regions. One or more, especially a plurality of the plurality of first outer regions, may each be configured between two second outer regions. In embodiments, the first outer regions and second outer regions may have different lengths or may have the same lengths. In embodiments, the first outer regions and the second outer regions alternate. In embodiments, the filament may comprise k1 first outer regions and k2 second outer regions. In embodiments, k1 and k2 may each independently be chosen from the range of at least 3, such as at least 5, like at least 7, such as in embodiments at least 10. In embodiments, the filament may comprise a core-shell filament. In other embodiments, the filament is not of the core-shell type.

In embodiments, the filament may comprise one or more first parts comprising the first 3D printable material and one or more second parts comprising the second 3D printable material. Hence, the one or more first parts may comprise the first outer regions and the one or more second parts may comprise the second outer regions. In embodiments, the first and second parts may alternate. As can be derived from the above, in embodiments the filament may comprise m1 first parts and m2 second parts. In embodiments, m1 and m2 may each independently be chosen from the range of at least 3, such as at least 5, like at least 7, such as in embodiments at least 10. In embodiments, the filament may consist of first parts and second parts. A length of the first parts and second parts may be relatively freely chosen, though in general, the lengths may be at maximum 50 mm, such as at maximum 30 mm, like in embodiments at maximum 20 mm. In other embodiments, the first parts and/or the second parts may have lengths of at least about 0.1 mm, more especially at least about 0.5 mm, like more especially at least about 1 mm.

In yet other embodiments, parts of the filament are of the core-shell type and other parts of the filament may not be of the core-shell type.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIGS. 2a-2f schematically depict some aspects of the method and/or of an embodiment of 3D printed material, and/or of an item;

FIG. 3 schematically depicts an application.

The schematic drawings are not necessarily to scale.

### DETAILED DESCRIPTION OF THE EMBODIMENTS

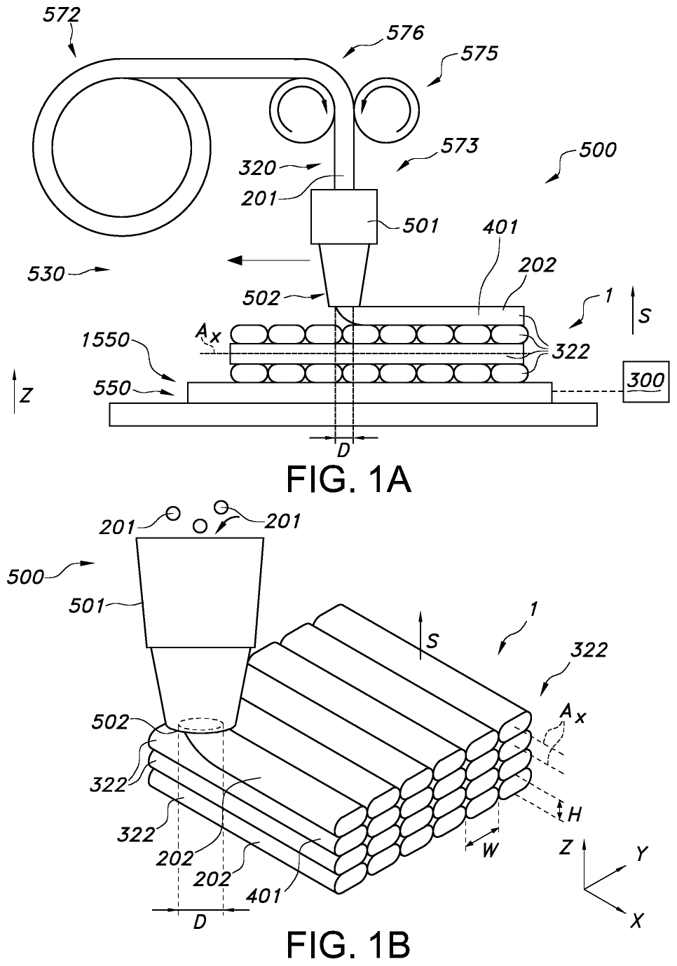

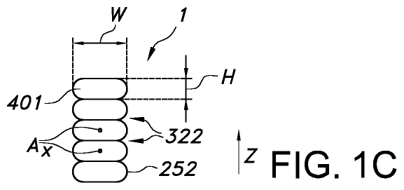

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as an FDM 3D printer head is schematically depicted. Reference 501 indicates the printer head. The 3D printer of the present invention may especially include a plurality of printer heads (see below). Reference 502 indicates a printer nozzle. The 3D printer of the present invention may especially include a plurality of printer nozzles, though other embodiments are also possible. Reference 320 indicates a filament of printable 3D printable material (such as indicated above).

Instead of a filament also pellets may be used as 3D printable material. Both can be extruded via the printer nozzle.

For the sake of clarity, not all features of the 3D printer have been depicted, only those that are of especial relevance for the present invention (see further also below). Reference 321 indicates extrudate (of 3D printable material 201).

The 3D printer 500 is configured to generate a 3D item 1 by layer-wise depositing on a receiver item 550, which may in embodiments at least temporarily be cooled, a plurality of layers 322 wherein each layers 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic polymer.

The 3D printer 500 may be configured to heat the filament 320 material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in an extrudate 321 downstream of the printer nozzle which becomes a layer 322 on the receiver item or on already deposited printed material. In general, the diameter of the extrudate 321 downstream of the nozzle 502 is reduced relative to the diameter of the filament 320 upstream of the printer head 501. Hence, the printer nozzle is sometimes (also) indicated as extruder nozzle. Arranging layer 322 by layer 322 and/or layer 322t on layer 322, a 3D item 1 may be formed. Reference 575 indicates the filament providing device, which here amongst others include the spool or roller and the driver wheels, indicated with reference 576.

Reference Ax indicates a longitudinal axis or filament axis.

Reference 300 schematically depicts a control system. The control system may be configured to control the 3D printer 500. The control system 300 may be comprised or functionally coupled to the 3D printer 500. The control system 300 may further comprise or be functionally coupled to a temperature control system configured to control the temperature of the receiver item 550 and/or of the printer head 501. Such temperature control system may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material. Hence, the nozzle 502 may effectively produce from particulate 3D printable material 201 a filament 320, which upon deposition is indicated as layer 322 (comprising 3D printed material 202). Note that during printing the shape of the extrudate may further be changes, e.g. due to the nozzle smearing out the 3D printable material 201/3D printed material 202. FIG. 1b schematically depicts that also particulate 3D printable material 201 may be used as feed to the printer nozzle 502.

Reference D indicates the diameter of the nozzle (through which the 3D printable material 201 is forced). However, the nozzle is not necessarily circular.

FIG. 1b schematically depicts in 3D in more detail the printing of the 3D item 1 under construction. Here, in this schematic drawing the ends of the layers in a single plane are not interconnected, though in reality this may in embodiments be the case. Reference H indicates the height of a layer. Layers are indicated with reference 322. Here, the layers have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIG. 1a schematically depict some aspects of a fused deposition modeling 3D printer 500, comprising (a) a first printer head 501 comprising a printer nozzle 502, (b) a filament providing device 575 configured to provide a filament 320 comprising 3D printable material 201 to the first printer head 501, and optionally (c) a receiver item 550, which can be used to provide a layer of 3D printed material 202.

FIG. 1b schematically depict some aspects of a fused deposition modeling 3D printer 500 (or part thereof), comprising a first printer head 501 comprising a printer nozzle 502, and optionally a receiver item (not depicted), which can be used to which can be used to provide a layer of 3D printed material 202. Such fused deposition modeling 3D printer 500 may further comprise a 3D printable material providing device, configured to provide the 3D printable material 201 to the first printer head.

In FIGS. 1a-1b, the first or second printable material or the first or second printed material are indicated with the general indications printable material 201 and printed material 202, respectively. Downstream of the nozzle 502, the filament 320 with 3D printable material becomes, when deposited, layer 322 with 3D printed material 202. In FIG. 1b, by way of example the extrudate is essentially directly the layer 322 of 3D printed material 202, due to the short distance between the nozzle 502 and the 3D printed material (or receiver item (not depicted).

FIG. 1c schematically depicts a stack of 3D printed layers 322, each having a layer height H and a layer width W. Note that in embodiments the layer width and/or layer height may differ for two or more layers 322. The layer width and/or layer height may also vary within a layer. Reference 252 in FIG. 1c indicates the item surface of the 3D item (schematically depicted in FIG. 1c).

Referring to FIGS. 1a-1c, the filament of 3D printable material that is deposited leads to a layer having a height H (and width W). Depositing layer 322 after layer 322, the 3D item 1 is generated. FIG. 1c very schematically depicts a single-walled 3D item 1.

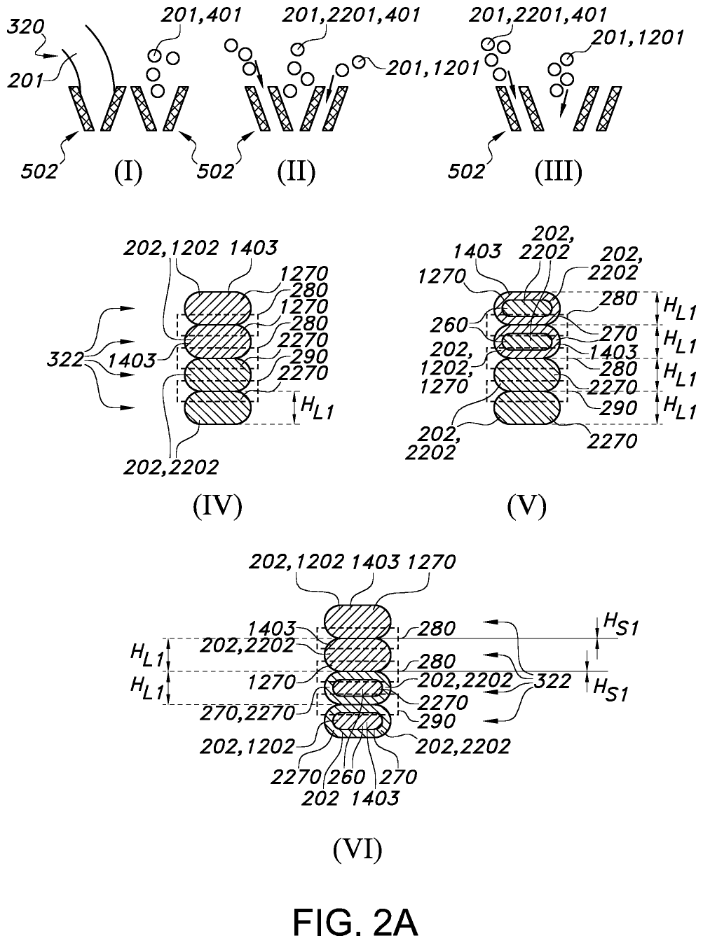

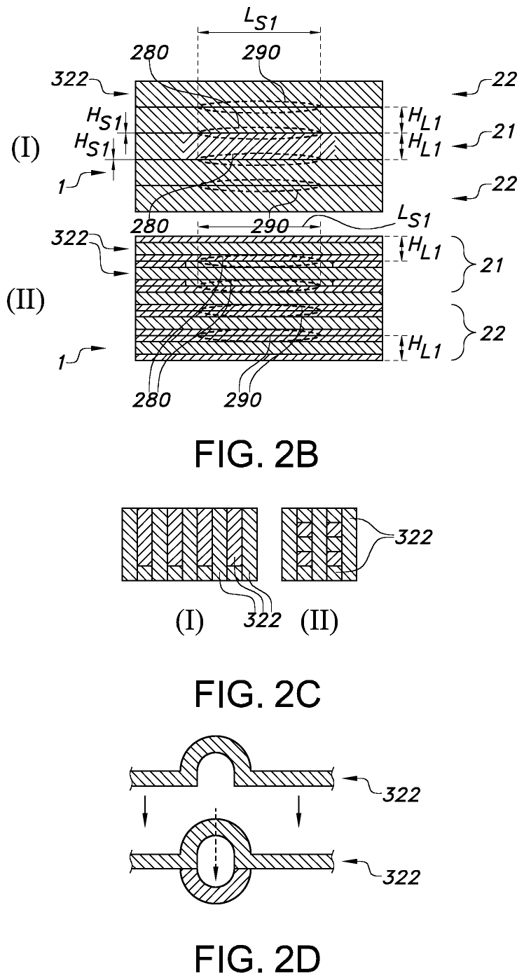

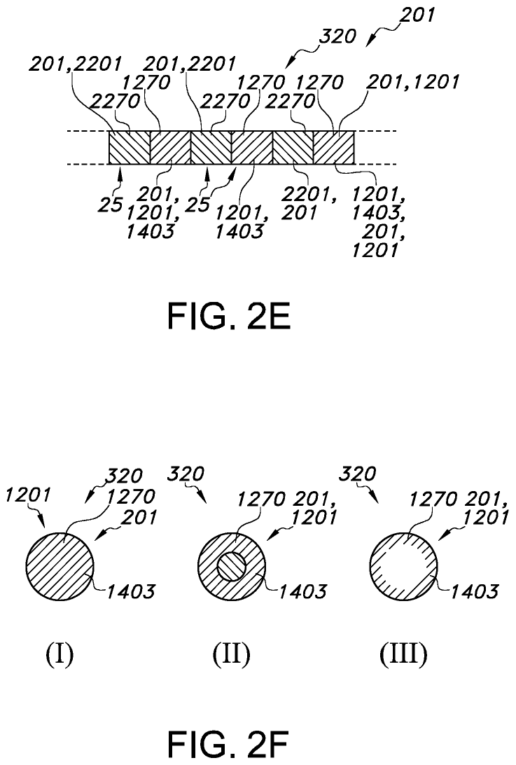

Referring to FIG. 2a-2f (and also FIGS. 1a-1c), amongst others the invention provides a method for producing a 3D item 1 by means of fused deposition modelling. Especially, the method may comprise layer-wise depositing 3D printable material 201 to provide the 3D item 1 comprising a plurality of layers 322 of 3D printed material 202.

The 3D printable material 201 may comprise (i) first 3D printable material 1201 comprising a fluoropolymer 1403 in a first outer region 1270 (of the first 3D printable material 1201) enclosing a first inner region (of the first 3D printable material 1201). Further, the 3D printable material 201 may comprise (ii) second 3D printable material 2201 free from a fluoropolymer 1403 in a second outer region 2270 (of the second 3D printable material 2201) enclosing a second inner region (of the second 3D printable material 2201).

In embodiments, in one or more first sections 280 of two adjacent layers 322 at least one of the layers 322 may comprise first 3D printed material 1202 comprising the fluoropolymer 1403 in the first outer region 1270 (of the 3D printed material 202). Alternatively or additionally, in one or more second sections 290 of two adjacent layers 322 the adjacent layers 322 both comprise second 3D printed material 2202 free from the fluoropolymer 1403 in the second outer regions 2270 (of the 3D printed material 202).

In embodiments, the fluoropolymer 1403 (of the first 3D printable material 1201 and the first 3D printed material 1202) may comprise one or more of polyvinylfluoride PVF, polyvinylidene fluoride PVDF, polytetrafluoroethylene PTFE, polychlorotrifluoro-ethylene PCTFE, perfluoroalkoxy polymer PFA, MFA, fluorinated ethylene-propylene FEP, polyethylenetetrafluoroethylene ETFE, and a copolymer made from 2,2-bistrifluoromethyl-4,5-difluoro-1,3-dioxole PPD and tetrafluoroethylene TFE.

In embodiments, the second 3D printable material 2201 and the second 3D printed material 2202 comprise one or more of polycarbonate PC, polyethylene PE, high-density polyethylene HDPE, polypropylene PP, polyoxymethylene POM, polyethylene naphthalate PEN, styrene-acrylonitrile resin SAN, polysulfone PSU, polyphenylene sulfide PPS, and semi-crystalline polytethylene terephthalate PET, acrylonitrile butadiene styrene ABS, polymethyl methacrylate PMMA, polystyrene PS, and styrene acrylic copolymers SMMA.

Especially, the first 3D printable material 1201 may comprise thermoplastic polymer. In embodiments the fluoropolymer may be a thermoplastic fluoropolymer. Further, especially the second 3D printable material 2201 (and the second 3D printed material 2202) comprise a thermoplastic polymer.

The weight percentage of fluoropolymer(s) in the first 3D printable material may be at least about 10 wt %, like in embodiments at least about 20 wt %. The weight percentage of fluoropolymer(s) in the second 3D printable material may be less than about 1 wt %, such as less than about 0.5 wt %.

Referring to FIG. 2a, embodiment I shows a non-core-shell nozzle 502 and embodiments II and III show core-shell nozzles 502. Especially embodiment I, but in principle also embodiments II and III, may provide the stack of layers of embodiment IV in FIG. 2a. Embodiments II and III may provide the stack of layers of embodiments V and VI.

The layer height H of the layers 320 is here indicated with HL1. Hence, in embodiments the layers 322 of the one or more first sections 280 have a layer height HL1. Further, in embodiments the one or more first sections 280 have a interlayer space height Hs1. In embodiments, Hs1/Ls1≤10. As schematically depicted, here the interlayer space height Hs1 may be essentially zero. Nevertheless, it may be possible in embodiments to move parts of the layers in the first section relative to each other, especially perpendicular to a stack of the layers 320. As shown in e.g. FIG. 2a, the term “section” may thus especially refer to a part of the 3D printed item 1 including part of a first layer and part of a second layer, wherein the first and the second layer are adjacent.

FIG. 2b schematically depicts side views of possible stacks. In embodiments, the one or more first sections 280 may have a section length Ls1. Especially, in embodiments 2≤Ls1/HL1≤40. In specific embodiments Ls1≤20 mm.

FIG. 2c schematically depict yet some further embodiments of 3D printed stacks.

Referring to FIG. 2d, in embodiments, one or more of the following may apply: (a) in the one or more first sections 280 the adjacent layers 322 are movable relative to each other, and (b) in the one or more first sections 280 the adjacent layers 322 have an opening 295 between the adjacent layers 322. Especially, the opening may be a slit or have the shape of a slit. Schematically, a pushing action is shown, whereby the layers may be partly moved relative to each other.

In embodiments, in at least one of the one or more first sections 280 of two adjacent layers 322 both layers 322 comprise first 3D printed material 1202 comprising the fluoropolymer 1403 in the first outer regions 1270. In embodiments, each first section 280 is configured between two second sections 290.

In embodiments, the method may comprise using a core-shell printer nozzle 502, wherein the method may comprise controlling deposition of the relative amounts of first 3D printable material 1201 and the second 3D printable material 2201 to provide the one or more first sections 280 and one or more second sections 290.

In embodiments, the method may comprise depositing 3D printable material 201 to provide (a) core-shell 3D printed material 202 and (b) non-core-shell 3D printed material 202.

In embodiments, the following may apply: (i) the core-shell 3D printed material 202 may comprise a core 260 and a shell 270 surrounding at least part of the core 260, wherein the shell 270 may comprise the fluoropolymer 1403 (and (thus) wherein the shell 270 of the core-shell 3D printed material 202 may comprise the first outer region 1270). Alternatively or additionally, the following may (also) apply: (ii) the second outer region 2270 of the non-core-shell 3D printed material 202 is free from the fluoropolymer 1403. In embodiments, (also) the following may apply: (a) the core-shell 3D printed material 202 may comprise a core 260 and a shell 270 surrounding at least part of the core 260, wherein the core 260 may comprise the fluoropolymer 1403, wherein the shell 270 is free from the fluoropolymer 1403 (and (thus) wherein the shell 270 of the core-shell 3D printed material 202 may comprise the second outer region 2270). Alternatively or additionally, the following may (also) apply: (b) the second outer region 2270 of the non-core-shell 3D printed material 202 may comprise the fluoropolymer 1403.

In embodiments, the following may apply: (i) the core-shell 3D printed material 202 may comprise a core 260 and a shell 270 surrounding at least part of the core 260, wherein the shell 270 may be free the fluoropolymer 1403 (and (thus) wherein the shell 270 of the core-shell 3D printed material 202 may comprise the second outer region 2270).

Alternatively or additionally, the following may (also) apply: (ii) the second outer region 2270 of the non-core-shell 3D printed material 202 may be free from the fluoropolymer 1403. In embodiments, (also) the following may apply: (a) the core-shell 3D printed material 202 may comprise a core 260 and a shell 270 surrounding at least part of the core 260, wherein the core 260 (and the shell 270) may be free from the fluoropolymer 1403 (and (thus) wherein the shell 270 of the core-shell 3D printed material 202 may comprise the second outer region 2270). Alternatively or additionally, the following may (also) apply: (b) the second outer region 2270 of the non-core-shell 3D printed material 202 may be free from the fluoropolymer 1403.

Referring to FIG. 2a-2f (and also FIGS. 1a-1c), amongst others the invention provides a 3D item 1 comprising 3D printed material 202. Especially, the 3D item 1 may comprise a plurality of layers 322 of 3D printed material 202.

In embodiments, the 3D printed material 202 may comprise: (i) first 3D printed material 1202 comprising a fluoropolymer 1403 in a first outer region 1270 of the first 3D printed material 1202 enclosing a first inner region of the first 3D printed material 1202. Alternatively or additionally, in embodiments, the 3D printed material 202 may comprise: (ii) second 3D printed material 2202 free from a fluoropolymer 1403 in a second outer region 2270 of the second 3D printed material 2202 enclosing a second inner region of the second 3D printed material 2202. In embodiments, (a) in one or more first sections 280 of two adjacent layers 322 at least one of the layers 322 may comprise first 3D printed material 1202 comprising the fluoropolymer in the first outer region 1270. Alternatively or additionally, (b) in one or more second sections 290 of two adjacent layers 322 the adjacent layers 322 both comprise second 3D printed material 2202 free from the fluoropolymer 1403 in the second outer regions 2270.

Referring to FIG. 2b, embodiments I and II, in embodiments, the 3D item 1 may comprise a first area 21 having a first area size A1 selected from the range of 1-1600 mm² comprising n1 first sections 280, wherein n1≥4, wherein each first sections 280 may have a section length Ls1; wherein the first area 21 may comprise a cumulative section length LS1≥20 mm; wherein each first section 280 is configured adjacent to a second section 290.

In embodiments, the 3D item 1 may comprise a second area 22 having a second area size A2 selected from the range of 1-1600 mm² comprising no first sections 280.

In embodiments, (i) the core-shell 3D printed material 202 may comprise a core 260 and a shell 270 surrounding at least part of the core 260, wherein the shell 270 may comprise the fluoropolymer 1403 (and (thus) wherein the shell 270 of the core-shell 3D printed material 202 may comprise the first outer region 1270); and (ii) the second outer region 2270 of the non-core-shell 3D printed material 202 is free from the fluoropolymer 1403.

In embodiments, (a) the core-shell 3D printed material 202 may comprise a core 260 and a shell 270 surrounding at least part of the core 260, wherein the core 260 may comprise the fluoropolymer 1403, wherein the shell 270 is free from the fluoropolymer 1403 (and (thus) wherein the shell 270 of the core-shell 3D printed material 202 may comprise the second outer region 2270); and (b) the second outer region 2270 of the non-core-shell 3D printed material 202 may comprise the fluoropolymer 1403.

Referring to FIG. 2a, embodiment I, especially FIG. 2e, and also FIGS. 1a-1c, amongst others the invention provides a filament 320 comprising 3D printable material 202, wherein the filament 320 may comprise (i) a fluoropolymer 1403 in a first outer region 1270 (of the filament 320) enclosing a first inner region (of the filament 320), and (ii) a second outer region 2270 (of the filament 320) enclosing a second inner region (of filament 320), wherein the second outer region 2270 is free from a fluoropolymer 1403. Schematically depicted in FIG. 2e, the 3D printable material 201 may be provided as filament 320 comprising one or more first parts comprising the first 3D printable material 1201 and comprising one or more second parts comprising the second 3D printable material 1201. The first and second parts are indicated with reference 25.

FIG. 2f schematically depict some possible embodiments of filaments 320 of 3D printable material, though this may analogously apply to layers of 3D printed material. Here, embodiments are shown of the first 3D printable material 201, though this may similarly apply to the second 3D printable material. Likewise, this may similarly apply to the first 3D printed material and the second 3D printed material.

Embodiment I schematically shows a filament 320 comprising a homogeneous distribution of the fluoropolymer 1403. Hence, in non-core shell material, the composition of the outer region and the inner region may thus be essentially identical. Embodiment II shows a filament 320 having a core-shell structure, with the fluoropolymer 1403 in the shell, and the core free from the fluoropolymer 1403. Embodiment III shows an embodiment of a filament 320 wherein there may be an inhomogeneous distribution of the fluoropolymer 1403. The filament 320 may be enriched with the fluoropolymer 1403 closer to the surface of the filament 320. Embodiments II and III may be very similar, or even essentially be the same.

All three embodiments of FIG. 2f show embodiments of first 3D printable material 1201 comprising a fluoropolymer 1403 in a first outer region 1270 (of the first 3D printable material 1201) enclosing a first inner region (of the first 3D printable material 1201). Similarly, this may thus apply for the second 3D printable material, which is free from a fluoropolymer in a second outer region (of the second 3D printable material) enclosing a second inner region (of the second 3D printable material).

Referring to embodiments II and III (and in fact also embodiment I, but then there may be substantially no difference between the inner region and the outer region), an outer region may comprise one or more different polymeric materials; alternatively or additionally, an inner region may comprise one or more different polymeric materials.

Referring to e.g. FIGS. 2e and 2f, but also FIGS. 2a-2d, in embodiments, the first 3D printable material may have a first glass transition temperature Tg1 and/or a first melting temperature Tm1, and the second 3D printable material may have a second glass transition temperature Tg2 and/or a second melting temperature Tm2. In embodiments, Tg2−30° C.≤Tg1≤Tg2+30° C. and/or Tm2−30° C.≤Tm1≤Tm2+30° C.

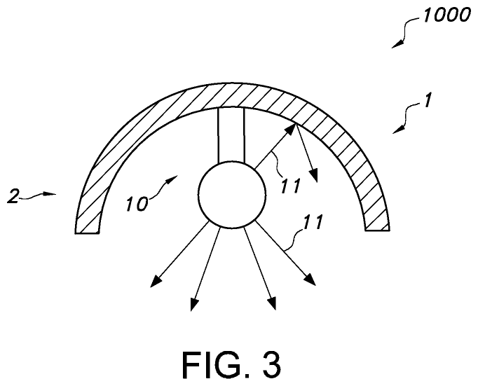

FIG. 3 schematically depicts an embodiment of a lamp or luminaire, indicated with reference 2, which comprises a light source 10 for generating light 11. The lamp may comprise a housing or shade or another element, which may comprise or be the 3D printed item 1. Here, the half sphere (in cross-sectional view) schematically indicates a housing or shade. The lamp or luminaire may be or may comprise a lighting device 1000 (which comprises the light source 10). Hence, in specific embodiments the lighting device 1000 comprises the 3D item 1. The 3D item 1 may be configured as one or more of (i) at least part of a lighting device housing, (ii) at least part of a wall of a lighting chamber, and (iii) an optical element. Hence, the 3D item may in embodiments be reflective for light source light 11 and/or transmissive for light source light 11. Here, the 3D item may e.g. be a housing or shade. The housing or shade comprises the item part 400. For possible embodiments of the item part 400, see also above.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A 3D item comprising 3D printed material, wherein the 3D item comprises a plurality of layers of 3D printed material, wherein:
the 3D printed material comprises (i) first 3D printed material comprising a fluoropolymer in a first outer region of the first 3D printed material enclosing a first inner region of the first 3D printed material, and (ii) second 3D printed material free from a fluoropolymer in a second outer region of the second 3D printed material enclosing a second inner region of the second 3D printed material;
(a) in one or more first sections of two adjacent layers at least one of the layers comprises first 3D printed material comprising the fluoropolymer in the first outer region, and (b) in one or more second sections of two adjacent layers the adjacent layers both comprise second 3D printed material free from the fluoropolymer in the second outer regions.

2. The 3D item according to claim 1, comprising a first area having a first area size A1 selected from the range of 1-1600 mm² comprising n1 first sections, wherein n1≥4, wherein each first sections has a section length (Ls1); wherein the first area comprises a cumulative section length LS1≥20 mm; wherein each first section is configured adjacent to a second section.

3. The 3D item according to claim 1, wherein the 3D printed material is core-shell 3D printed material, and wherein one or more of the following applies:
(i) the core-shell 3D printed material comprises a core and a shell surrounding at least part of the core, wherein the shell comprises the fluoropolymer; and (ii) the second outer region of the non-core-shell 3D printed material is free from the fluoropolymer; and
(a) the core-shell 3D printed material comprises a core and a shell surrounding at least part of the core, wherein the core comprises the fluoropolymer, wherein the shell is free from the fluoropolymer; and (b) the second outer region of the non-core-shell 3D printed material comprises the fluoropolymer.

4. The 3D item according to claim 1, wherein:
the fluoropolymer comprises one or more of polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, and a copolymer made from 2,2-bistrifluoromethyl-4,5-difluoro-1,3-dioxole and tetrafluoroethylene; and
the second 3D printed material comprise one or more of polycarbonate, polyethylene, high-density polyethylene, polypropylene, polyoxymethylene, polyethylene naphthalate, styrene-acrylonitrile resin, polysulfone, polyphenylene sulfide, and semi-crystalline polyethylene terephthalate, acrylonitrile butadiene styrene, poly(methyl methacrylate), polystyrene, and styrene acrylic copolymers,
one or more of the following applies: (a) in the one or more first sections the adjacent layers are movable relative to each other, and (b) in the one or more first sections the adjacent layers have an opening between the adjacent layers;
each first section is configured between two second sections; and
the layers of the one or more first sections have a layer height, wherein the one or more first sections have a section length, wherein 2≤Ls1/HL1≤40, and wherein Ls1≤20 mm.

5. A lighting device comprising the 3D item according to claim 1, wherein the 3D item is configured as one or more of at least part of a lighting device housing, at least part of a wall of a lighting chamber, and an optical element.

6. A method for producing, by means of fused deposition modelling using a core-shell printer nozzle, the 3D item according to claim 1, wherein:
the method comprises layer-wise depositing 3D printable material to provide the 3D item comprising a plurality of layers of 3D printed material;
the 3D printable material comprises first 3D printable material comprising a fluoropolymer in a first outer region enclosing a first inner region, and second 3D printable material free from a fluoropolymer in a second outer region enclosing a second inner region;
in one or more first sections of two adjacent layers at least one of the layers comprises first 3D printed material comprising the fluoropolymer in the first outer region, and
in one or more second sections of two adjacent layers the adjacent layers both comprise second 3D printed material free from the fluoropolymer in the second outer regions, and
wherein the method comprises controlling deposition of the relative amounts of first 3D printable material and the second 3D printable material to provide the one or more first sections and one or more second sections.

7. The method according to claim 6, wherein the fluoropolymer comprises one or more of polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, and a copolymer made from 2,2-bistrifluoromethyl-4,5-difluoro-1,3-dioxole and tetrafluoroethylene.

8. The method according to claim 6, wherein the second 3D printable material and the second 3D printed material comprise one or more of polycarbonate, polyethylene, high-density polyethylene, polypropylene, polyoxymethylene, polyethylene naphthalate, styrene-acrylonitrile resin, polysulfone, polyphenylene sulfide, and semi-crystalline polytethylene terephthalate, acrylonitrile butadiene styrene, poly(methyl methacrylate), polystyrene, and styrene acrylic copolymers; and wherein the second 3D printable material and the second 3D printed material comprise a thermoplastic polymer.

9. The method according to claim 6, wherein in at least one of the one or more first sections of two adjacent layers both layers comprise first 3D printed material comprising the fluoropolymer in the first outer regions.

10. The method according to claim 6, wherein each first section is configured between two second sections.

11. The method according to claim 6, wherein the layers of the one or more first sections have a layer height, wherein the one or more first sections have a section length, wherein 2≤Ls1/HL1≤40, and wherein Ls1≤20 mm; wherein the one or more first sections have a interlayer space height, wherein Hs1/Ls1≤10.

12. The method according to claim 6, comprising depositing 3D printable material to provide core-shell 3D printed material and non-core-shell 3D printed material; wherein one or more of the following applies:
the core-shell 3D printed material comprises a core and a shell surrounding at least part of the core, wherein the shell comprises the fluoropolymer; and the second outer region of the non-core-shell 3D printed material is free from the fluoropolymer; and
the core-shell 3D printed material comprises a core and a shell surrounding at least part of the core, wherein the core comprises the fluoropolymer, wherein the shell is free from the fluoropolymer; and the second outer region of the non-core-shell 3D printed material comprises the fluoropolymer.

13. A filament comprising 3D printable material, wherein the filament comprises a fluoropolymer in a first outer region enclosing a first inner region, and a second outer region enclosing a second inner region, wherein the second outer region is free from a fluoropolymer.
